(19) United States
(12) Patent Application Publication
(10) Pub. No.: US 2025/0313382 A1
(43) Pub. Date: Oct. 9, 2025

(54) ERGONOMIC HANDLE

(71) Applicant: Brium Brands, LLC, Supply, NC (US)

(72) Inventors: Michael Schultz, Supply, NC (US); Aaron Clymer, Grand Junction, CO (US)

(73) Assignee: Brium Brands, LLC, Supply, NC (US)

(21) Appl. No.: 18/953,633

(22) Filed: Nov. 20, 2024

Related U.S. Application Data
(60) Provisional application No. 63/610,045, filed on Dec. 14, 2023.

(51) Int. Cl. B65D 25/28; A47G 19/22

(52) U.S. Cl. CPC B65D 25/2829; A47G 19/2205

(57) ABSTRACT

An ergonomic handle may include an approximately straight section configured to be grasped by one or more of a user's index finger, middle finger, and/or ring finger. The ergonomic handle may further include a widened section that may include an inward curve and a concave curve. The remaining fingers of the hand which may include the middle finger, ring finger, and/or little finger may push against the widened section when the hand is holding the ergonomic handle. The widened section, inward curve, and concave curve may all assist the user in allowing the user to hold the ergonomic handle in a natural hand position. The widened section may allow a larger area for the remaining fingers to push against and the inward curve and concave curve may align with the natural shape of the user's fingers making the ergonomic handle more comfortable to use.

### RELATED APPLICATIONS

This application claims priority to U.S. Provisional Application Ser. No. 63/610,045, filed Dec. 14, 2024.

### BACKGROUND OF THE INVENTION

Handles are used to assist a user in lifting and using a given object. For example, drinking cups, mugs, and bottles, all referred to herein as mugs, often contain handles to assist a user in lifting and drinking from the mug. The handle may also assist the user in allowing the user to use the mug without having to hold a part of the mug which may be too hot for the hand. Traditional handles are often awkward to hold for the user. Additionally, traditional handles may be impossible for a user with weakened hands, or conditions such as arthritis, to hold and use with one hand.

Accordingly, there has been an ongoing need for improvements in handle designs to improve the overall comfort, quality, and usability of the handle for users regardless of hand strength. Therefore, new handle designs that are also ergonomic would be well received by the public.

### SUMMARY OF THE INVENTION

An ergonomic handle may be connected to an object and configured to assist a user in lifting, holding, and using the object. The object may be, but is not limited to, a drinking cup, mug, bottle, or the like. The ergonomic handle may include a first end, an approximately straight section, a widened section, and a second end. The approximately straight section may be positioned superiorly to the widened section.

The ergonomic handle may also include an inward curve curving inward towards the object to which the handle is connected. The ergonomic handle may also include a concave curve located within the inward curve. The inward curve may be positioned within the widened section of the handle.

The approximately straight section may be configured to be grasped by one or more of an index finger, a middle finger, and/or a ring finger of a carrying hand of the user. The concave curve may be configured to receive one or more of the middle finger, the ring finger, and/or a little finger of the carrying hand of the user, the one or more fingers pushing against the concave curve. As such, the handle may be gripped in a number of different positions with one or more fingers grasping the approximately straight section and one or more fingers pushing against the concave curve within the inner curve of the widened section. With this style of grip, some fingers grasping and some fingers pushing, the user may have an easier time lifting and using the object, and may also have a more comfortable experience.

The handle may connect to the object at a single point, such as the first end or the second end, with the end that is not attached being a floating end. Alternatively, the handle may be connected at both ends to the object. In some embodiments, the handle may be one continuous piece. In other embodiments, a lower section contains the widened section, inward curve, and concave curve, may be a separate and distinct section from an upper section containing the approximately straight section.

The handle may have a width greater than its thickness. As such, the handle may be in the shape of a flat bar.

Other features and advantages of the various embodiments of the ergonomic handle will become apparent from the following more detailed description, taken in conjunction with the accompanying drawings, which illustrate, by way of example, the principles of the various embodiments of the ergonomic handle and the various methods.

### BRIEF DESCRIPTION OF THE DRAWINGS

Various embodiments, methods, and systems will be described herein and explained with additional specificity and detail through the use of the accompanying drawings, in which:

FIG. 1 illustrates a perspective view of an ergonomic handle;

FIG. 2 illustrates a left side elevational view of the ergonomic handle of FIG. 1 the right side elevational view being a mirror image thereof;

FIG. 3 illustrates a front elevational view of the ergonomic handle of FIGS. 1 and 2;

FIG. 4 illustrates a top plan view of the ergonomic handle of FIGS. 1-3; and

FIG. 5 illustrates a cross-sectional view taken at 5-5 of FIG. 2 of the ergonomic handle of FIGS. 1-4.

### DETAILED DESCRIPTION OF THE PREFERRED EMBODIMENTS

As shown in the drawings and for purposes of illustration, the one or more embodiments disclosed herein illustrate an ergonomic handle generally referred to herein by the reference numeral 10. Generally, the ergonomic handle 10 may include a first end 12, an approximately straight section 14, an inward curve 16, a concave curve 18, a widened section 20, and a second end 22. The first end 12 and the approximately straight section 14 may make up an upper section of the handle. The inward curve 16, the concave curve 18, the widened section 20, and the second end 22 may make up a lower section of the handle. The ergonomic handle 10 may be one continuous piece from the first end 12 through the second end 22. In alternative embodiments, the upper section may be distinct from the lower section. In general, the ergonomic handle 10 may be connected to, or a part of, an object that is designed to be carried and used by a user. For example, the object may be a drinking cup, mug, bottle or other similar kitchen piece, however, the ergonomic handle is not limited to only being used with these objects. For purposes of illustration, without limitation, throughout this disclosure, the ergonomic handle 10 will be referred to as being attached, or a part of, a mug 24. In some embodiments, the ergonomic handle 10 may be in the shape of a flat bar, such that the width of the ergonomic handle 10 is greater in measurement than the depth of the ergonomic handle 10. However, the ergonomic handle is not limited to such a shape and may take on various forms. The ergonomic handle 10 may assist a user in lifting and using the mug 24. The design of the ergonomic handle 10 may allow a user with weak or limited hand functionality, or any variety of user, to lift and use the mug in a comfortable manner.

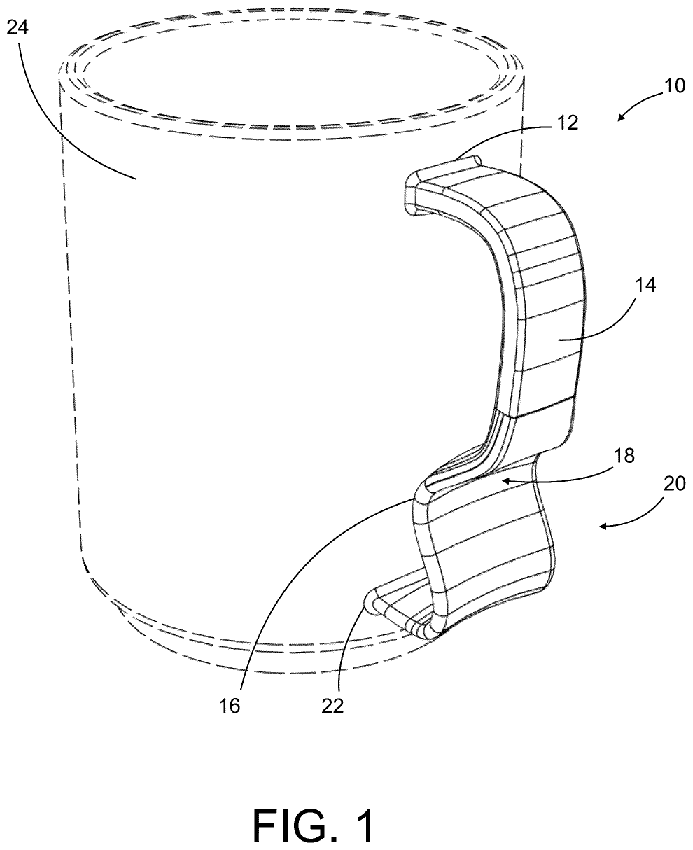

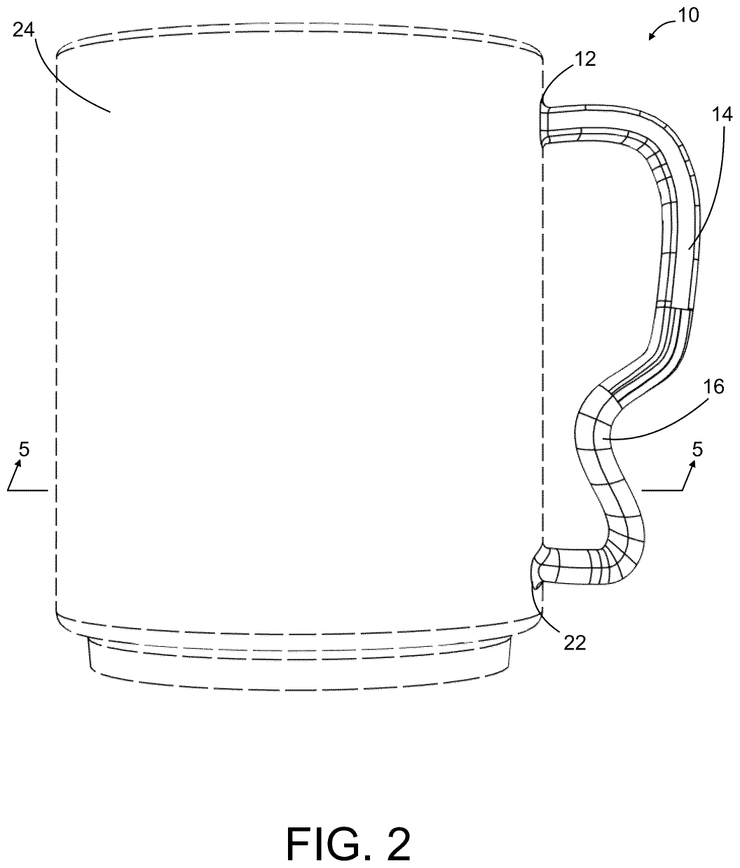

With Reference now to FIGS. 1 and 2, various features of the ergonomic handle 10 are illustrated. As already mentioned above, an upper section of the ergonomic handle 10 may include a first end 12 and an approximately straight section 14. The first end 12 may be attached to or be one with the mug 24. From the first end 12, the ergonomic handle 10 may extend approximately orthogonally from the mug 24 and then curve downwards into an approximately straight section 14 that is approximately parallel to the mug 24. Some embodiments may have the approximately straight section 14 exactly parallel with the mug while other embodiments will vary slightly from being exactly parallel with the mug. Some embodiments may have the approximately straight section 14 being exactly straight while other embodiments may have the approximately straight section 14 be slightly curved or otherwise varied from being perfectly straight.

The approximately straight section 14 may connect to the lower section by connecting to, or being one with, the inward curve 16. The lower section may include the inward curve 16 and the second end 22. The inward curve 16 may curve inward such that the peak of the inward curve 16 is closer to the mug 24 than the majority of the ergonomic handle 10. From the inward curve 16 to the second end 22, the ergonomic handle may curve back to being approximately orthogonal to the mug 24 through to the second end 22. The second end 22 may be connected to, or one with, the mug 24.

In some embodiments, the ergonomic handle 10 may be connected to, or one with, the mug 24 such that both the first end 12 and the second end 22 are connected to, or one with, the mug 24. In other embodiments, the ergonomic handle 10 may only be connected to or one with, the mug 24 at the first end 12, such that the first end 12 is connected to, or one with, the mug 24. In such embodiments, the second end 22 of the ergonomic handle 10 may not be connected to anything and simply be a floating end of the ergonomic handle 10. In yet other embodiments, the ergonomic handle 10 may only be connected to, or one with, the mug 24 at the second end 22, such that the second end 22 is connected to, or one with, the mug 24. In such embodiments, the first end 12 of the ergonomic handle 10 may not be connected to anything and simply be a floating end of the ergonomic handle 10.

In some embodiments, the ergonomic handle 10 may be one continuous piece from the first end 12 of the ergonomic handle 10 through the second end 22 of the ergonomic handle 10. In other embodiments, the upper section of the ergonomic handle 10, including the first end 12 and approximately straight section 14 may be separate and distinct from the lower section of the ergonomic handle 10, including the inward curve 16 and the second end 22. In such embodiments, a separation or space may be present between the approximately straight section 14 and the inward curve 16.

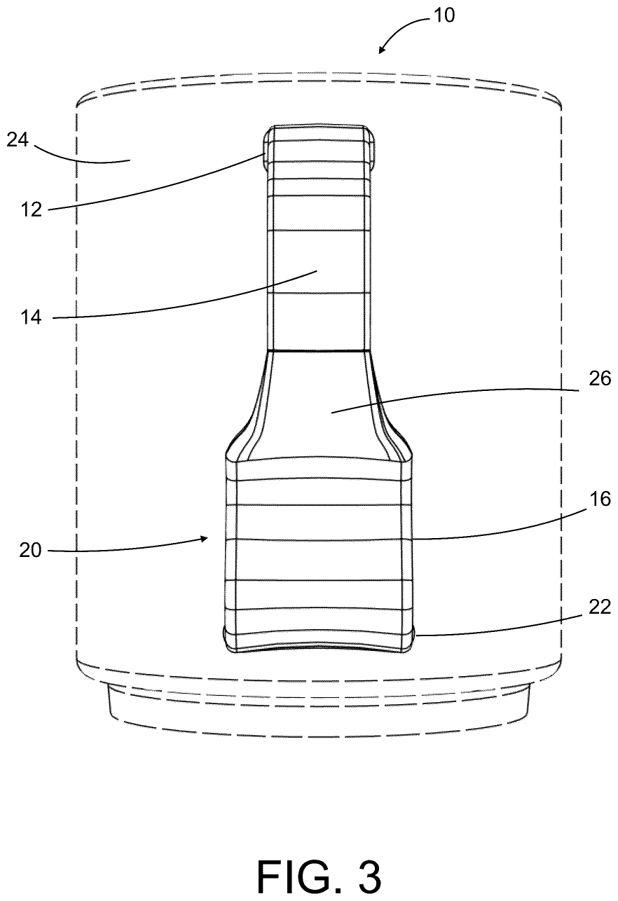

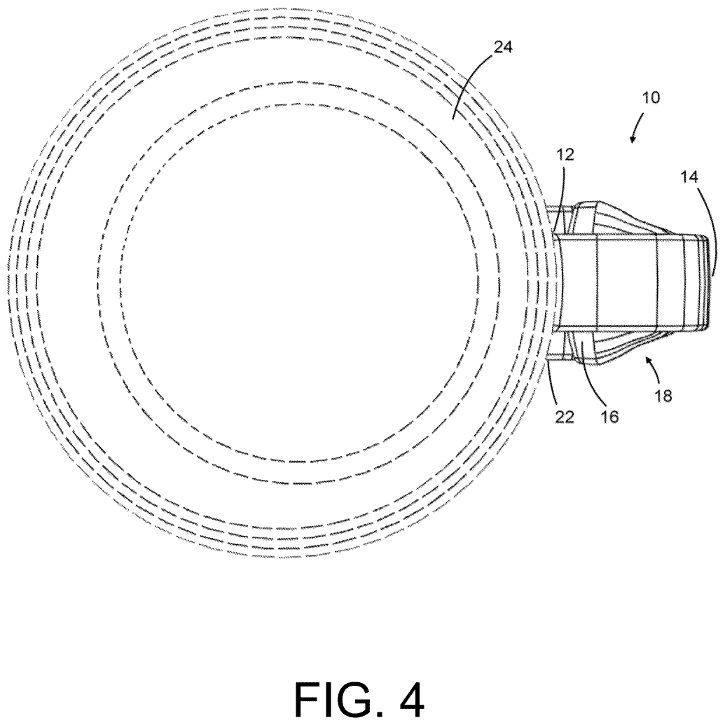

With reference now to FIGS. 3 and 4, some embodiments of the the ergonomic handle 10 may include a widened section 20 as already mentioned above. The widened section 20 may have a width that is greater than the width of the rest of the ergonomic handle 10. The inward curve 16 may be positioned within the widened section 20. In some embodiments, the widened section 20 may make up the majority of the lower section of the ergonomic handle. Some embodiments may include a transitional section 26 that transitions the ergonomic handle 10 from a smaller width at the approximately straight section 14 to the larger width at the widened section 20.

In some embodiments, and as best seen in FIG. 3, the widened section 20 may, from a straight on elevational view, be in the shape of a quadrilateral such as a rectangle. However, the widened section 20 is not limited to such a shape and may be in any shape, such as but not limited to, a square, circle, oval, or any other shape.

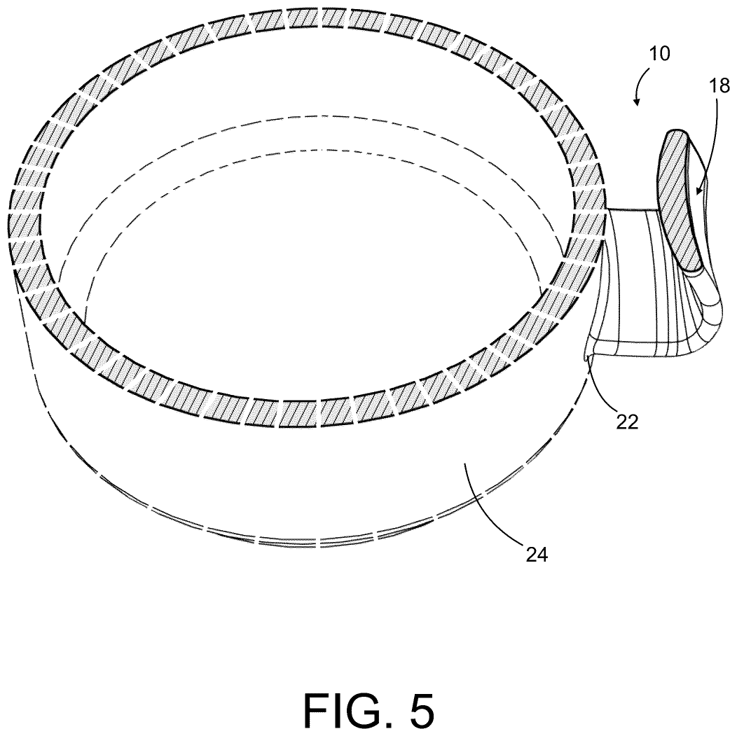

With reference now to FIG. 5, and as may also be seen in FIG. 1, some embodiments of the ergonomic handle 10 may include a concave curve 18 as already mentioned above. FIG. 5 illustrates a cross-section taken along the line 5-5 in FIG. 2. This view may best show the concave curve 18. The concave curve 18 may be positioned horizontally and within the widened section 20. The concave curve 18 may additionally be positioned within the inward curve 16. The concave curve 18 may further push the peak of the inward curve 16 closer to the mug 24.

When holding the mug 24 by the ergonomic handle 10, a user may grasp the upper section of the ergonomic handle 10 with one or more of the user's index finger, middle finger, and/or ring finger of a user's holding hand. When grasping the upper section of the ergonomic handle 10, one or more of the user's index finger, middle finger, and/or ring finger may grasp around the approximately straight section 14. The fingers that are not grasping the approximately straight section 14, which may include the middle finger, ring finger, and/or little finger, may push against the widened section 20. in some embodiments, these remaining fingers may rest in and push against the inward curve 16 and concave curve 18. As already mentioned above, the inward curve 16 and concave curve 18 may be a part of the widened section 20. The widened section 20 may give more surface area for the remaining fingers to push against in a comfortable manner. The inward curve 16 may be designed such that these remaining fingers may more comfortably push against the widened section in a more natural hand position. The concave curve 18 may further increase comfort as it may be designed to follow the natural curve of the remaining fingers pushing against it. These features all assist the user in being able to hold the ergonomic handle 10 in a natural hand position in a comfortable and easy manner such that the mug 24 is supported.

Although specific embodiments of the ergonomic handle 10 have been described in detail above for purposes of illustration, various modifications may be made without departing from the scope and spirit of the invention. Accordingly, the invention is not to be limited except as by the appended claims.

What is claimed is:

1. An ergonomic handle comprising:
a top section;
a bottom section;
an inward curve; and
a concave curve;
the handle being connected to an object, the object intended to be carried by a user;
the inward curve being located within the bottom section and curving inward toward the object;
the concave curve being located within the inward curve and configured to receive one or more of a middle finger, a ring finger, and/or a little finger of a carrying hand of a user, the one or more fingers pushing against the concave curve.

2. The ergonomic handle of claim 1, further comprising the top section being configured to be grasped by one or more of an index finger, the middle finger, and/or the ring finger of the carrying hand of the user.

3. The ergonomic handle of claim 1 further comprising a widened section, the widened section being a part of the bottom section and being wider than the rest of the handle.

4. The ergonomic handle of claim 3, wherein the inward curve and the concave curve being a part of the widened section.

5. The handle of claim 1, wherein the top section is connected to the object and the bottom section is one with the top section.

6. The ergonomic handle of claim 1, wherein the bottom section is connected to the object and the top section is one with the bottom section.

7. The ergonomic handle of claim 1, wherein the top section is connected to the object, the bottom section is connected to the object, and top section is distinct from the bottom section.

8. The ergonomic handle of claim 1, wherein the top section is connected to the object, the bottom section is connected to the object, and the top section and the bottom section are one.

9. The handle of claim 1, wherein the object is a mug.

10. An ergonomic handle comprising:
a first end;
a second end;
an inward curve; and
a concave curve;
the inward curve curving inward toward a mug, the first and second ends of the handle being connected to the mug;
the concave curve being located within the inward curve and configured to receive one or more of a middle finger, a ring finger, and/or a little finger of a carrying hand of a user, the one or more fingers pushing against the concave curve.

11. The ergonomic handle of claim 10 further comprising an approximately straight section, the approximately straight section being configured to be grasped by one or more of an index finger, the middle finger, and/or the ring finger of the carrying hand of the user.

12. The ergonomic handle of claim 11, wherein the approximately straight section is positioned superiorly to the inward curve.

13. The ergonomic handle of claim 10, wherein a width of the handle is greater than the thickness of the handle such that the handle is approximately the shape of a flat bar.

14. The ergonomic handle of claim 10, further comprising a widened section, the widened section inferior to the approximately straight section and having a greater width than the approximately straight section.

15. The handle of claim 14, wherein the inward curve is located within the widened section.

16. An ergonomic handle comprising:
a first end;
an approximately straight section;
a widened section
an inward curve;
a concave curve; and
a second end;
the inward curve curving inward toward a mug, the handle being attached to a mug, and being located within the widened section;
the concave curve being located within the inward curve; and
the approximately straight section being positioned superiorly to the widened section.

17. The ergonomic handle of claim 16, wherein the first end is attached to the mug.

18. The ergonomic handle of claim 16 wherein the second end is attached to the mug.

19. The ergonomic handle of claim 17, wherein the second end is attached to the mug.

20. The ergonomic handle of claim 16 wherein, the approximately straight section is configured to be grasped by one or more of an index finger, a middle finger, and/or a ring finger of a carrying hand of a user and wherein the concave curve is configured to receive one or more of the middle finger, the ring finger, and/or a little finger of the carrying hand of the user, the one or more fingers pushing against the concave curve.
